(19) United States
(12) Patent Application Publication
(10) Pub. No.: US 2002/0187461 A1
(43) Pub. Date: Dec. 12, 2002

(54) Death visualization therapy

(76) Inventors: Arnold P. Nerenberg, Whittier, CA (US); Jerry Shepherd, Whittier, CA (US)

Correspondence Address: Schmeiser, Olsen & Watts, Suite 201, 3 Lear Jet Lane, Latham, NY, 12110, US

(21) Appl. No.: 10/211,217

(22) Filed: Aug. 1, 2002

Related U.S. Application Data
(62) Division of application No. 09/584,610, filed on May 31, 2000.

(51) Int. Cl. G09B 19/00

(52) U.S. Cl. 434/236

(57) ABSTRACT

A therapeutic method and structure that facilitates healing estranged relationships, enhancing positive relationships, and breaking destructive habits. A first person is directed to see a second person in a coffin. Prior to directing the first person to see the second person in a coffin, the first person may be tested for contraindications. The coffin may contain a pillow and may be closed, partially open, or fully open. The second person may, or may not, be in the coffin. The first person is prompted to express an emotion to the second person, followed by the first person expressing the emotion to the second person. The prompting may be by a facilitator such as a professional therapist or a member of the clergy. The emotion may be any emotion. Examples of such emotions expressed by the first person include: a love for the second person, a missing of the second person, an appreciation of what the second person did for the first person, a regret for having shown the second person disrespect, and a wish for a second chance to relate to the second person. The first person may be further directed to envision himself or herself as being at the first person's moment of despair (MOD) in relation to a destructive habit that the first person has. There may also be a post-testing phase in which the first person responds to questions that include the first person's attitude toward the second person.

### BACKGROUND OF THE INVENTION

1. Technical Field

The present invention of Death Visualization Therapy relates to a therapeutic method and structure that relates to healing estranged relationships, enhancing positive relationships, and breaking destructive habits.

2. Related Art

Existing methods for healing estranged relationships, enhancing positive relationships, and breaking destructive habits generally require therapy or other treatment over long periods of time such as over weeks, months, or years. Such lengthy treatment is not only time consuming and expensive, but also may prove to be unsuccessful or minimally successful after an expenditure of substantial time and money.

A method is needed for healing estranged relationships, enhancing positive relationships, and breaking destructive habits in a short period of time, in a manner that produces long-term beneficial results.

### SUMMARY OF THE INVENTION

The present invention provides a therapeutic method, comprising the steps of:

providing a coffin, wherein the coffin is visually available to a first person;

directing the first person to see a second person as being in the coffin; and

prompting the first person to express to the second person an emotion that the first person has in relation to the second person.

The present invention provides a therapeutic method, comprising the steps of:

pretesting a first person for a contraindication against continuing with the method;

if the pretesting step fails to disclose the contraindication,

providing a coffin, wherein the coffin is visually available to the first person;

directing the first person to see a second person as being in the coffin; and

prompting the first person to express to the second person an emotion that the first person has in relation to the second person.

The present invention provides a therapeutic structure, comprising:

a coffin, said coffin being visually available to a first person;

a visual image of a second person lying in the coffin, said visual image being seen by the first person; and

an expression of an emotion that the first person has in relation to the second person, said expression being expressed by said first person.

Applications of the present invention include, inter alia, healing estranged relationships, enhancing positive relationships, and breaking destructive habits, in a manner that produces long-term beneficial results, and in a time-efficient manner that is cost effective.

By having a first person mentally experiences a sense of loss of a second person, the present invention creates a strong appreciation of the second person by the fist person.

The present invention may heal both a first person and a second person even though the second person may have a passive role in the method of the present invention.

The present invention may include pretesting the first person for contraindications against continuing with the method of the present invention.

The present invention may include having a post-testing phase which is both evaluative and therapeutic.

### BRIEF DESCRIPTION OF THE DRAWINGS

FIG. 1 depicts a top view of a coffin, a first person, and a facilitator, in accordance with embodiments of the present invention.

FIG. 2 depicts a side cross-sectional view of the coffin of FIG. 1.

### DETAILED DESCRIPTION OF THE INVENTION

The present invention of Death Visualization Therapy relates to a therapeutic method and structure that facilitates healing estranged relationships, enhancing positive relationships, and breaking destructive habits. Given a first person and a second person in a relationship, the relationship may be healed or enhanced by increasing an appreciation of the second person by the first person, and vice versa. The present invention is based on the idea that we don't appreciate what we have until we lose it. Thus, by inducing the first person's sense or impression of loss of the second person, the first person gains an increased appreciation of the second person which has the effect of healing or enhancing the relationship. The present invention utilizes a coffin for inducing the first person's sense or impression of loss of the second person.

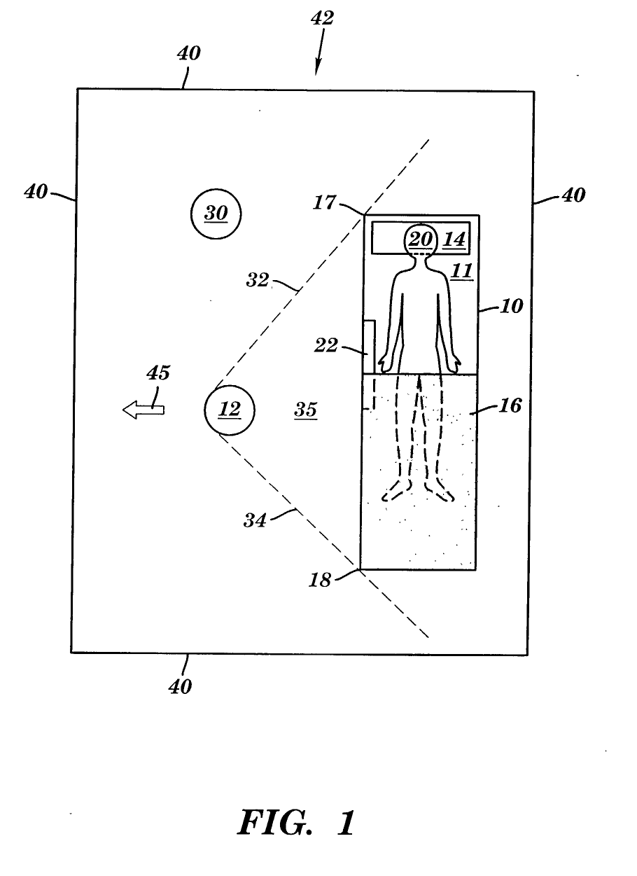

FIG. 1 illustrates a top view of a space 42 that includes a coffin 10, a first person 12, and a facilitator 30, in accordance with embodiments of the present invention. The space 42 may include a boundary 40 which defines a closed space such as a room of a building. Alternatively, the space 42 may be an open space wherein the boundary 40 is absent, such as a cemetery, lawn, park, etc. Additionally, the space 42 may be partially open (or, equivalently, partially closed) such that a percentage P of the boundary 40 is absent, wherein 0%<P<100% (e.g., a hallway having both walls and open ends). The coffin 10 may be, inter alia, a prototypical coffin; i.e., any coffin that a funeral director of ordinary skill in the art of funeral directing would consider to be practical or commercially viable for use in a funeral. The coffin 10 is visually available to the first person 12 by virtue of being located in a space 35 defined by lines 32 and 34 respectively drawn from the first person 12 to the edges 17 and 18 of the coffin 10. The coffin 10 is visually available to the first person 12 even if the first person 12 is facing away (such as in a direction 45) from the coffin 10, since the first person 12 could rotate by an angle that would make the coffin 10 visible to the first person 12.

The coffin 10 may include a second person 20, a pillow 4, and an electronic device 22. If the pillow 4 is present, then the pillow 4 may or may not be visually available to the first person 12. The electronic device 22 may be portable. Alternatively, the electronic device 22 may be integral with the coffin 10, or otherwise constrained, such that the electronic device 22 cannot be easily moved out of the coffin. The electronic device 22 may include, inter alia, an audio device that records and/or plays sound (e.g., a tape recorder, a tape player), a video device (e.g. a video recoding device, a video playing device), or combinations thereof. If a tape playing device or a video playing device, the electronic device 22 may be used to generate sound of any type in such form as, inter alia, funeral music, religious music, favorite music of the first person 12, favorite music of the second person 20, human cries of despair, eery sounds, etc.

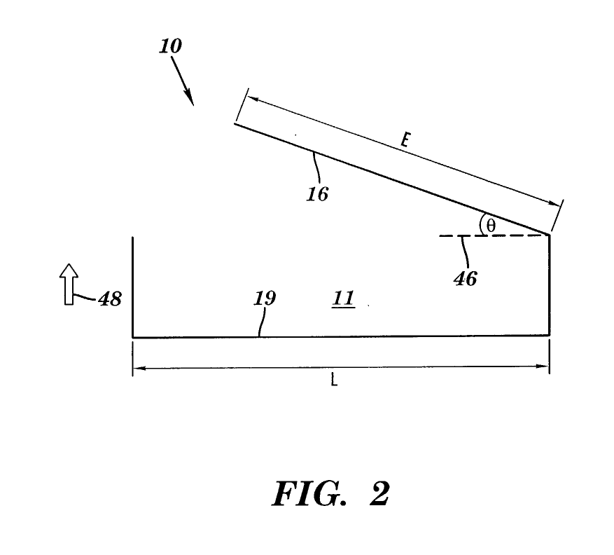

The coffin 10 may include a top end (or cover) 16. If present, the top end 16 may partially or totally cover an interior space 11 of the coffin 10 in various ways, such as is shown in FIG. 2, which illustrates a side cross-sectional view of the coffin 10 of FIG. 1 such that a height of the coffin is in a direction 48. In FIG. 2, the top end 16 of the coffin 10 has a length E and makes an angle θ with respect to a direction along a line 46 that is about parallel to a bottom surface 19 of the coffin 10, wherein θ is expressed in degrees. The permitted values of E and θ are: E≧0 and θ≧0. Noting that L denotes a length of the coffin 10, the top end 16 of the coffin 10 totally covers the coffin 10 (i.e., the coffin 10 is fully closed) when θ=0 and E≧L. The coffin 10 is fully open (i.e., the coffin 10 is fully open) if E=0, or if E>0 and θ≧90. For all other combinations of E and θ, the top end 16 of the coffin 10 partially covers the coffin 10 (i.e., the coffin 10 is partially open or partially closed). Although that the top end 16 is shown in FIG. 2 as one rigid piece, the top end 16 may include an type of a top of the coffin 10 that would be known to a funeral director of ordinary skill in the art of funeral directing. For example, the top end 16 may comprise multiple sections such that one section could cover a portion of the coffin 10 while another section would be oriented in a manner that leaves a portion of the coffin 10 open.

The second person 20 is a living person who may be in the coffin 10, in the space 42 but not in the coffin 10, or outside of the space 42. The first person 12 and the second person 20 have a relationship which may be familial (e.g., husband and wife, parent and child, brother and sister) or non-familial (e.g., friends, business associates). As stated supra, the structure and method of the present invention may be used to heal or enhance the relationship between the first person 12 and the second person 20. The structure and method of the present invention may also be used to help the first person 12 break a destructive habit, and the relationship between the first person 12 and the second person 20 will serve as a vehicle to help the first person 12 break the destructive habit as will be explained infra.

The facilitator 30 is capable of facilitating, prompting, and directing the first person 12 to perform a physical or mental action as described infra. The facilitator 30 may be a person. Alternatively, the facilitator 30 may be a facilitating device (e.g., a tape recorder) capable of performing said facilitating, prompting, or directing. If a person, the facilitator 30 may be, inter alia, a professional therapist (e.g., psychologist, psychiatrist, social worker) or a member of the clergy (e.g., minister, priest, rabbi).

The method of the present invention comprises at least a first step, a second step, and a third step. The first step includes providing the coffin 10 such that the coffin is visually available to the first person 12. Under lighted conditions, an object is said to be visually available to a person who is not totally blind, if any portion of the object is visible to the person who is not totally blind, or would be visible to the person who is not totally blind if the person who is not totally blind were to turn his or her head without engaging in translational motion. Under conditions of darkness, an object is said to be visually available to a person who is not totally blind if the object would be visually available to the person who is not totally blind under lighted conditions. Under either light conditions or conditions pf darkness, the object is said to be visually available to a totally blind person, if the coffin 10 would be visually available to a person not totally blind and standing in place of the totally blind person. Thus, the coffin 10 may be visually available to the first person 12 under either lighted or darkness conditions, regardless of whether or not the first person 12 is totally blind.

As stated supra, the boundary 40 may or may not be present. Thus, the method of the present invention could be practiced indoors or outdoors. Note that the method of the present invention could be practiced indoors in any private or public location (e.g., a private residence, a business office, a church, a shopping mall, a pub, a social hall, a submarine, a prison cell, a spacecraft, etc.). Also note that the method of the present invention could be practiced outdoors in any private or public location (e.g., a private yard, a cemetery, a city street corner, a zoo, a mountain top, a forest, etc.), under any environmental condition (e.g., sunshine, rain, snow, freezing temperature, earthquake, etc.).

The second step of the method of the present invention includes directing the first person 12 to see the second person 20 as being in the coffin 10. In one embodiment, seeing the second person 20 in the coffin 10 requires the second person 20 to be in the coffin 10 such that the first person 12 physically sees the second person 20 in the coffin 10. In another embodiment, seeing the second person 20 in the coffin 10 is accomplished by mentally visualizing the second person 20 as being in the coffin 10 (said mental visualizing being accomplished by the first person 12) regardless of whether or not the second person 20 is actually in the coffin 10. The first person 12 is said to physically see or mentally visualize the second person 20 in the coffin if the first person 12 physically sees or mentally visualizes any portion of the body of the second person 20 as being in direct physical contact with the coffin 10, said direct physical contact may include a portion of the body of the second person 20 being within an interior space 11 of the coffin 10 (e.g., lying, sitting or standing in the coffin 10). Thus, it is within the scope of the present invention for the second person 20 to be seen or visualized as being in physical contact with only an exterior portion of the coffin 10. Mental visualization may be aided by having an object identified with the second person 20 in the coffin 10, such as a picture of the second person 20 or a piece of jewelry that the first person 12 identifies with the second person 20.

The “directing” in the second step may be accomplished either with or without the facilitator 30. If the facilitator 30 is a person, then the facilitator 30 may accomplish said directing in any manner, such as by commanding, suggesting, begging, threatening, etc. If the facilitator 30 is a facilitating device (e.g., a tape recorder), then the facilitator 30 may accomplish said directing in a predetermined manner (e.g., by playing a specific tape on the tape recorder). The directing may be accomplished without a facilitator in any manner, such as by the first person 12 self-directing himself or herself to see the second person 20 as being in the coffin 10.

The first step and the second step of the method of the present invention collectively serve to initiate a sense or impression of loss by the first person 12 of the second person 20. A third step is utilized to deepen or intensify the aforementioned sense or impression of loss so as to induce a significantly enhanced appreciation of the second person 20 by the first person 12. Accordingly, the third step of the method of the present invention includes prompting the first person 12 to express to the second person 20 an emotion that the first person 12 has in relation to the second person 20. The emotion may be any positive emotion such as love, appreciation, gratitude, respect, trust, admiration, etc. The expression of the emotion may be verbal, non-verbal, oral, by conduct, or through combinations thereof. As an example, the expression of the emotion may be accomplished by the first person 12 saying, by talking or thinking, to the second person 20 (irrespective of whether or not the second person 20 is physically present) such words as, inter alia: “I love you”; “I miss you”; “I appreciate what you did for me”; “I am sorry that I showed you disrespect”; “I wish that I had a second chance”; and combinations thereof. As another example, the first person 12 may: weep; smile; bow in reverence; physically or mentally touch, hold, or kiss the second person 20, etc. There is virtually no limit to the manner in which the first person 12 may express the emotion to the second person 20.

The prompting in the third step may be accomplished either with or without the facilitator 30. If the facilitator 30 is a person, then the facilitator 30 will accomplish said prompting in any manner, such as by commanding, suggesting, begging, threatening, etc. If the facilitator 30 is a facilitating device (e.g., a tape recorder), then the facilitator 30 will accomplish said prompting in a predetermined manner (e.g., by playing a specific tape on the tape recorder). The prompting may be accomplished without a facilitator in any manner, such as by the first person 12 self-prompting himself or herself to express the emotion to the second person 20.

The aforementioned three steps (i.e., the first step, the second step, and the third step) collectively serve to create a sense or impression of loss of the second person 20 by the first person 12 so as to substantially increase the appreciation of the second person 20 by the first person 12. As a result, the relationship between the first person 12 and the second person 20 will be healed if estranged, or enhanced if positive and not estranged.

The present invention may also be used to help the first person 12 break a destructive habit that may include, inter alia, a habitual practice such as: a habitual using of an illegal drug, a habitual smoking of tobacco, a habitual drinking of alcoholic beverages to a point of intoxication, a habitual aggressive driving of a motor vehicle, or a habitual showing of disrespect to a parent of the first person 12. To accomplish this, the present invention assumes that the first person 12 has a love for the second person 20. Accordingly, the present invention supplements the aforementioned three steps with a fourth step in which the first person 12 envisions being at his or her own moment of despair (MOD) in relation to the destructive habit. The MOD of the first person 12 occurs when the first person 12 experiences a very strong, nearly uncontrollable urge to practice the destructive habit. The emotion expressed in the third step may also be utilized for combating the destructive habit, such as by sensitizing the first person 12 to an adverse effect of the destructive habit. For example, if the first person 12 is a drug addict and the second person 20 is a son of the first person 12, then the first person 12 may express his love and regret to the second person 20 for having been such a poor role model for the second person 20 that the second person 20 imitated the drug habit of the first person 12 and died from a drug overdose. The particular emotion expressed in the third step in relation to the destructive habit is application dependent and there is no inherent limit to the type of emotion and the manner of expressing the emotion. The third and fourth steps, in combination, enable the first person 12 to envision being at the MOD in accordance with the fourth step, while also expressing the emotion to the second person 20 in accordance with the third step. By using both the third step and the fourth step, the present invention enables the first person 12 to mentally and emotionally link his or her love for the second person 20 with the urges and temptations that occur during the MOD. Thus by causing first person 12 to express an emotion in relation to the second person 20, the “prompting” step of the present invention provides an energization that intensifies the emotional strength of the first person 12, which enhances the ability of the first person 12 to resist engaging in the destructive habit when the first person 12 is truly at his or her MOD.

The love that the first person 12 has for the second person 20 may be further utilized for breaking a destructive habit by conditioning the first person 12 to use a “trigger” to induce a “power thought” in the first person 12. A “power thought” in the first person 12 is a thought by the first person 12 that envisions the destructive habit as causing an adverse consequence to the first person 12. For example, the power thought of the first person 12 may be a thought of the second person 20 as being dead in the coffin 10 because of the drug habit of the first person 12. In that example, the imagined death of the second person 20 by the first person 12 is an adverse consequence to the first person 12, if the first person 12 attributes the imagined death of the second person 20 to the drug habit of the first person 12 and thus experiences a sense of loss or of guilt. A “trigger” may be, inter alia, an object belonging to the first person 12, such as a watch or a ring. For example, the first person 12 may be conditioned to think of the second person 20 as being dead in the coffin 10 every time that the first person 12 sees his or her watch (i.e., the watch belonging to the first person 12). Here, the watch is the trigger. The first person 12 may be further instructed to make a pledge to purposefully and regularly use the trigger, such as by looking at his or her watch regularly or periodically (e.g., once per hour for a predetermined time measure such as a lifetime of the first person 12, a duration of a marriage of the first person 12, six months, etc.) even when not in not in the presence of the coffin 10. Said regular or periodic use of the trigger serves to regularly induce a perception (e.g., a visualization) of the power thought in the mind of the first person 12 and to make the power thought become automatic when the first person 12 is at his or her MOD. The power thought provides the first person 12 with inner strength to resist practicing the destructive habit when at his or her MOD. Note that the trigger activates the power thought, while the “prompting” step of the present invention (which prompts the first person 12 to express an emotion in relation to the second person 20) provides an energization that intensifies the strength of the power thought.

In an alternative embodiment for breaking destructive habits, the second person 20 is the same person as the first person 12. Thus, in this alternative embodiment, the second person 20 is the first person 12. The “directing” step described supra includes directing the first person 12 to see himself or herself in the coffin 10. The “prompting” step described supra includes prompting the first person 12 to express an emotion that the first person 12 has in relation to himself or herself, such as expressing an emotional feeling of grief or sadness in seeing himself or herself as dead in the coffin 10. The fourth step described supra has the first person 12 envisioning himself or herself as being at his or her MOD. The first person 12 may also be conditioned to use a “trigger” to induce a “power thought” in himself or herself. For example, the first person 12 may be conditioned to think of himself or herself as being dead in the coffin 10 every time that the first person 12 sees his or her watch, wherein the watch serves as a trigger. The first person 12 may be further instructed to purposefully and regularly use the trigger, such as looking at his or her watch regularly or periodically (e.g., once per hour for a predetermined time measure such as a lifetime of the first person 12, a duration of a marriage of the first person 12, six months, etc.) even when not in not in the presence of the coffin 10. Said regular or periodic use of the trigger serves to regularly induce a perception (e.g., a visualization) of the power thought in the mind the first person 12 and to make the power thought become automatic when the first person 12 is at his or her MOD. Note that the trigger activates the power thought, while the “prompting” step of the present invention (which prompts the first person 12 to express an emotion in relation to himself or herself such as a feeling of loss of freedom or of function) provides an energization that intensifies the strength of the power thought.

The present invention may include pre-testing (i.e., testing prior to the first step, the second step, and the third step) of the first person 12 to determine if implementing the three steps (i.e., first step, the second step, and the third step) is contraindicated. The pre-testing may include, inter alia, questions requiring a “yes” or “no” response, to several questions such as any or all of the following questions wherein the first person 12 is a child in a relationship with the second person 20 who is a parent of the first person 12:

“Have you made a suicide attempt in the last five years?”;

“Are you seriously thinking about taking your life?”;

“In the last five years have you heard voices that only you can hear?”;

“In the last five years have you seen people or things that only you can see?”;

“Do you love your Mother?”;

“Do you hate your Mother?”;

“Do you love your Father?”; and

“Do you hate your Father?”.

As an example of how to use the pre-testing results, if the first person 12 is a child of the second person 20 and the first person 12 answers “no” to the question of “Do you love your Mother?” or “Do you love your Father?”, then the three or four steps of the present invention may be contraindicated since an absence of love, if true or if perceived, may preclude a favorable outcome of the Death Visualization Therapy.

The present invention may include post-testing (i.e., testing subsequent to the first step, the second step, and the third step) the first person 12 by having the first person 12 respond to questions that pertain to the attitude of first person 12 toward the second person 20. If the first person 12 is a child of the second person 20, then the post-testing may include, inter alia, questions requiring a “yes” or “no” response, such as any or all of the following questions:

“Did the therapy bring you closer to your parent?”;

“Did you get more in touch with your love?”;

“Did the therapy help you more deeply cherish your parent?”;

“Do you feel more regret over having disrespected your parent?”;

“Are you more aware of how much you would miss your parents if your parents were no longer here?”;

“Do you feel more motivated to treat your parents with more respect and consideration?”;

“Do you feel the treatment helped you?”;

“Do you think the benefits will be long lasting?”:

“Will you think about the experience when you leave the office?”; and

“Has the trust between you and your parents been strengthened?”;

The post-testing serves both an evaluative and a therapeutic purpose. The evaluative purpose is realized because of the questions' focus on ascertaining information concerning thoughts and attitudes of the first person 12 as a consequence of the Death Visualization Therapy that the first person 12 participated in. The therapeutic purpose is realized because, in answering the post-testing questions, the positive attitudes and emotions of the first person 12 toward the second person 20 are reinforced by the thought processes of the first person 12 while answering the post-testing questions. For example, in answering “yes” to the question “Did the therapy bring you closer to your parent?”, the first person 12 has engaged in a focused awareness of his or her feeling of closeness to the second person 20.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

We claim:

1. A therapeutic method, comprising the steps of:
providing a coffin, wherein the coffin is visually available to a first person;
directing the first person to see a second person as being in the coffin; and
prompting the first person to express to the second person an emotion that the first person has in relation to the second person.

2. The method of claim 1, wherein the second person is not in the coffin.

3. The method of claim 1, wherein the second person is in the coffin.

4. The method of claim 1, wherein “to express” is selected from the group consisting of to verbally express, to non-verbally express, and a combination thereof.

5. The method of claim 1, wherein the directing and prompting steps are performed by a facilitator.

6. The method of claim 5, wherein the facilitator is selected from the group consisting of a professional therapist and a member of the clergy.

7. The method of claim 1, wherein the coffin includes a pillow that is visually available to the first person.

8. The method of claim 7, wherein a top end of the coffin partially covers the coffin.

9. The method of claim 1, further comprising operating an electronic device, said electronic device located within the coffin.

10. The method of claim 9, wherein the electronic device is selected from the group consisting of an audio device, a video device, and combinations thereof.

11. The method of claim 1, further comprising after the prompting step expressing the emotion, said expressing being accomplished by the first person.

12. The method of claim 11, wherein the emotion includes an emotional feeling selected from the group consisting of a love for the second person, a missing of the second person, an appreciation of what the second person did for the first person, a regret for having shown the second person disrespect, and a wish for a second chance to relate to the second person, and combinations thereof.

13. The method of claim 11, further comprising after the expressing step, post-testing the first person by having the first person respond to questions that pertain to the first person's attitude toward the second person.

14. The method of claim 1, further comprising directing the first person to envision himself or herself as being at his or her moment of despair (MOD) in relation to a destructive habit that the first person has.

15. The method of claim 14, further comprising conditioning the first person to use a trigger to induce a power thought in the first person.

16. The method of claim 14, further comprising directing the first person to pledge using a trigger for regularly inducing a power thought in the first person.

17. The method of claim 14, wherein the destructive habit includes a habitual practice selected from the group consisting of a habitual using of an illegal drug, a habitual smoking of tobacco, a habitual drinking of alcoholic beverages to a point of intoxication, a habitual aggressive driving of a motor vehicle, and a habitual showing of parent disrespect.

18. The method of claim 14, wherein the second person is the first person.

19. A therapeutic method, comprising the steps of:
pretesting a first person for a contraindication against continuing with the method;
if the pretesting step fails to disclose the contraindication,
providing a coffin, wherein the coffin is visually available to the first person;
directing the first person to see a second person as being in the coffin; and
prompting the first person to express to the second person an emotion that the first person has in relation to the second person.

20. The method of claim 19, further comprising after the prompting step expressing the emotion, said expressing being accomplished by the first person.

21. The method of claim 20, further comprising after the expressing step post-testing the first person by having the first person respond to questions that pertain to the first person's attitude toward the second person.

22. A therapeutic structure, comprising:
a coffin, said coffin being visually available to a first person;
a visual image of a second person lying in the coffin, said visual image being seen by the first person; and
an expression of an emotion that the first person has in relation to the second person, said expression being expressed by said first person.

23. The structure of claim 22, wherein the second person is not in the coffin.

24. The structure of claim 22, wherein the second person is in the coffin.

25. The structure of claim 22, wherein the expression is selected from the group consisting of a verbal expression, a non-verbal expression, and a combination thereof.

26. The structure of claim 22, wherein the coffin includes a pillow that is visually available to the first person.

27.The structure of claim 22, wherein a top end of the coffin partially covers the coffin.

28. The structure of claim 22, wherein the emotion includes an emotional feeling selected from the group consisting of a love for the second person, a missing of the second person, an appreciation of what the second person did for the first person, a regret for having shown the second person disrespect, and a wish for a second chance to relate to the second person, and combinations thereof.

29. The structure of claim 22, further comprising an envisioning by the first person of the first person being at the first person's moment of despair (MOD) in relation to a destructive habit that the first person has.

30. The structure of claim 29, further comprising a directing of the first person to pledge using a trigger for inducing a power thought in the first person.

31. The structure of claim 29, further comprising a conditioning of the first person to use a trigger to regularly induce a power thought in the first person.

32. The structure of claim 29, wherein the destructive habit includes a habitual practice selected from the group consisting of a habitual using of an illegal drug, a habitual smoking of tobacco, a habitual drinking of alcoholic beverages to a point of intoxication, a habitual aggressive driving of a motor vehicle, and a habitual showing of parent disrespect.

33. The structure of claim 29, wherein the second person is the first person.

34. A therapeutic structure, comprising a coffin, said coffin being visually available to a first person, wherein a visual image of a second person lying in the coffin is being seen by the first person, and wherein an emotion that the first person has in relation to the second person is being expressed by the first person, and wherein said second person is not in the coffin.
